(19) United States
(12) Patent Application Publication
(10) Pub. No.: US 2015/0264871 A1
(43) Pub. Date: Sep. 24, 2015

(54) PLANT CULTIVATION SYSTEM AND METHOD

(71) Applicants: Caine Finnerty, Port Washington, NY (US); Benjamin Emley, Bolivar, OH (US); Paul DeWald, Glen Cove, NY (US)

(72) Inventors: Caine Finnerty, Port Washington, NY (US); Benjamin Emley, Bolivar, OH (US); Paul DeWald, Glen Cove, NY (US)

(73) Assignee: WATT Fuel Cell Corp., Port Washington, NY (US)

(21) Appl. No.: 14/220,704

(22) Filed: Mar. 20, 2014

(51) Int. Cl. A01G 9/18; A01G 31/00

(52) U.S. Cl. CPC A01G 9/18; A01G 31/00

(57) ABSTRACT

The electrical power, carbon dioxide and heating requirements of an enclosed plant cultivation system and method, for example, a greenhouse and greenhouse plant cultivation method, are provided by a solid oxide fuel cell.

### BACKGROUND OF THE INVENTION

This invention relates to plant cultivation systems such as solar and indoor greenhouses and to plant cultivation methods employing such systems.

Modern plant cultivation systems (inclusive of plant cultivation structures) may be considered as belonging to one of three main types: outdoor greenhouses that depend upon solar radiation as the primary, if not the exclusive, source of photosynthetically active radiation (PAR), indoor greenhouses that depend upon artificial lighting, for example, grow lights, as the primary, if not the exclusive, source of PAR, and greenhouses of a hybrid type, i.e., those that depend largely upon solar radiation for PAR during times of adequate sunshine and partially or entirely upon artificial lighting for PAR at other times.

Depending on their location, outdoor greenhouses that depend entirely on solar PAR may include one or more systems for maintaining a suitable plant cultivation environment, for example, heating, ventilation and/or dehumidification systems for maintaining a desired range of temperature and/or humidity, shading systems for adjusting the amount of solar radiation received at different times of the day and/or reducing the loss of solar heat that occurs on cloudy days and during the night, systems for monitoring and regulating the greenhouse environment, and the like. These systems require a source of energy for their operation, for example, the burning of fuel for heating and electricity for powering electrical, electromechanical and electronic devices.

Indoor greenhouses and hybrid-type greenhouses, in addition to incorporating one or more of the foregoing systems commonly associated with outdoor greenhouses, in their use of artificial lighting such as grow lights and horticultural lamps tend to consume large amounts of electricity all or most of which is typically drawn from the power grid.

US 2012/0279121 discloses a wheeled vehicle having a chassis upon which are mounted a direct methanol fuel cell (DMFC), methanol fuel tank, electric drive system and control unit. The DMFC provides electricity for the operation of the electric drive system and control unit and for powering light emitting diodes (LEDs) mounted on the underside of the vehicle. The vehicle includes a skirt defining a plant growth chamber (which may be likened to an indoor greenhouse) on the underside of the vehicle. In operation, and utilizing the electrical output of its on-board DMFC, the vehicle is driven by its control unit to a predetermined location, for example, an area of damaged grass on a sports field. Once the vehicle is in place, its LEDs are switched on with the resulting PAR and carbon dioxide, heat and water vapor produced by the DMFC being directed toward the area of damaged grass thereby promoting new grass growth.

For reasons that will be explained below, there are a number of drawbacks and disadvantages to DMFCs as sources of electrical power, carbon dioxide, heat and water for greenhouse operation that make them less than ideal candidates for this application.

### SUMMARY OF THE INVENTION

In accordance with the present invention, there is provided a plant cultivation system which comprises:
a) a plant cultivation enclosure; and,
b) a solid oxide fuel cell electrically connected to at least one electrical power-consuming device disposed within the plant cultivation enclosure, waste heat and carbon dioxide outputs of the solid oxide fuel cell being in thermal and in gaseous flow communication, respectively, with the interior of the plant cultivation enclosure.

Further in accordance with the present invention, there is provided a method of plant cultivation which comprises:
a) placing at least one plant to be cultivated within a plant cultivation enclosure having a source of water, a source of nutrients essential to the growth of the plant and at least one electrical power-consuming source of photosynthetically active radiation;
b) operating at least one solid oxide fuel cell to provide electrical current for the operation of the at least one electrical power-consuming source of photosynthetically active radiation, waste heat and carbon dioxide outputs of the solid oxide fuel cell being introduced into the plant cultivation enclosure to at least partly bring about and/or maintain environmental conditions within the plant cultivation enclosure that are favorable to the growth of the plant; and,
c) cultivating the at least one plant under the favorable environmental conditions at least partly brought about and/or maintained by operating the at least one solid oxide fuel cell.

The enclosed plant cultivation system and method of this invention, both of which utilize a solid oxide fuel cell (SOFC), have numerous advantages over enclosed plant cultivation systems and methods that utilize a DMFC such as the DMFC-powered mobile plant growth chamber disclosed in US 2012/0279121. These advantages lie in the nature of the fuels, working temperatures, electrical efficiencies and design features of SOFCs compared with those of DMFCs.

While SOFCs can be designed to operate on methanol as a fuel (employing an altogether different type of chemistry/electrochemistry than that of a DMFC), they are advantageously operated with liquid and/or gaseous hydrocarbon fuels that have significantly higher energy contents than methanol and as storehouses of electrochemical energy are correspondingly superior to the latter. In addition, there are a far greater number of distribution outlets for liquid and gaseous hydrocarbons than there are for methanol. This is especially the case with natural gas which in addition to its lower cost, may be brought directly to such end use devices as SOFCs by an extensive network of pipeline distribution (gas grid).

Another major advantage of SOFCs over DMFCs are the much higher working temperatures of the former (800-1100° C.) compared with the latter (90-120° C.). While usable high-grade waste heat can be readily recovered in the case of SOFCs and be used to provide heating for the plant cultivation enclosure, heat produced by the operation of DMFCs is fairly negligible and any attempt to recover this heat such as it is runs the risk of quenching the reaction whereby the methanol fuel is converted to hydrogen. Unlike SOFCs, DMFCs are not a practical or useful source of heat for plant cultivation enclosures.

Yet another major advantage of SOFCs over DMFCs are their efficiencies (cell), in the case of SOFCs ranging from 60-65% and in the case of DMFCs ranging from 10-20%.

Design differences between SOFCs and DMFCs (reflecting their different chemistries/electrochemistries) tend to weigh in favor of the former as sources of electrical power, carbon dioxide and waste heat for greenhouse operation. While SOFCs can utilize a variety of low cost catalytically active metals, for example, nickel containing catalysts, DMFCs require the use of expensive noble metal catalysts, for example, those based on platinum.

SOFCs by virtue of their design are also far less susceptible to fuel crossover, i.e., fuel penetrating the electrolyte membrane separating the anode and cathode components of the fuel cell, than DMFCs. Methanol crossover in DMFCs continues to cause difficulty for the reliable operation of this type of fuel cell despite ongoing efforts to develop a satisfactory technical solution to the problem.

The plant cultivation system and method of the invention featuring the utilization of an SOFC to provide electrical current, carbon dioxide and heating for the system and method will be more fully understood from the following figures, description, detailed explanatory embodiments and claims.

### BRIEF DESCRIPTION OF THE DRAWINGS

FIG. 1A is a cross section of a greenhouse in accordance with the present teachings taken through line 1′-1′ of FIG. 1B in the direction of the arrow shown therein.

FIG. 1B is a plan view of the greenhouse of FIG. 1A taken through line 1-1 in the direction of the arrows shown therein.

FIG. 2 is a schematic block diagram of an embodiment of integrated liquid fuel catalytic partial oxidation reformer (CPDX)-SOFC system for incorporation in the greenhouse of FIGS. 1A and 1B.

FIG. 3A is a schematic block diagram of an exemplary control system for managing the operation of the integrated liquid fuel CPDX reformer-SOFC system of FIG. 2.

FIG. 3B is a flow chart of an exemplary control routine executed by a controller such as the control system illustrated in FIG. 3A.

FIG. 4 is a schematic block diagram of an embodiment of integrated gaseous fuel CPDX reformer-SOFC system for incorporation in the greenhouse of FIGS. 1A and 1B.

FIG. 5A is a schematic block diagram of an exemplary control system for managing the operations of the integrated gaseous fuel CPDX reformer-SOFC system of FIG. 4.

FIG. 5B is a flowchart of an exemplary control routine executed by a controller such as the control system illustrated in FIG. 5A.

FIG. 6A is a schematic block diagram illustrating an environmental control system for the control of the plant cultivation system according to the present disclosure.

FIG. 6B presents a flow chart of an exemplary control routine that can be executed by a controller of the environmental control system to automate the operation of the plant cultivation system. The thresholds (TH) shown therein can be preset thresholds or controlled by a user depending on the needs of the plants.

FIG. 6C presents a flow chart of an exemplary control routine that can be executed by a controller of the environmental control system to automate the operation of the charging of the battery for the plant cultivation system.

FIG. 6D presents a flow chart of an exemplary control routine that can be executed by a controller of the environmental control system to automate the operation of the shades of the plant cultivation system.

### DETAILED DESCRIPTION OF THE INVENTION

It is to be understood that the present teachings are not limited to the particular procedures, materials and modifications described and as such can vary. It is also to be understood that the terminology used is for purposes of describing particular embodiments only and is not intended to limit the scope of the present teachings which will be limited only by the appended claims.

Throughout the application, where systems, structures, apparatus, devices, compositions, etc., are described as comprising, including or having specific elements or components, or where methods are described as comprising, including or having specific method steps or operations, it is contemplated that such systems, structures, apparatus, devices, compositions, etc., also consist essentially of, or consist of, the recited elements or components and that such methods also consist essentially of, or consist of, the recited method steps or operations.

In the application, where an element or component is said to be included in and/or selected from a list of recited elements or components, it should be understood that the element or component can be any one of the recited elements or components or the element or component can be selected from a group consisting of two or more of the recited elements or components. Further, it should be understood that elements and/or features of a system, structure, apparatus, device, composition, method or operation described herein can be combined in a variety of ways without departing from the focus and scope of the present teachings whether explicit or implicit therein. For example, where reference is made to a particular structure, that structure can be used in various embodiments of the apparatus and/or method of the present teachings.

The use of the terms “include,” “includes,” “including,” “have,” “has,” “having,” “contain,” “contains,” or “containing,” including grammatical equivalents thereof, should be generally understood as open-ended and non-limiting, for example, as not excluding additional unrecited elements or steps, unless otherwise specifically stated or understood from the context.

The use of the singular herein, for example, “a,” “an,” and “the”, includes the plural (and vice versa) unless specifically stated otherwise.

Where the term “about” precedes a quantitative value, the present teachings also include the specific quantitative value itself, unless specifically stated otherwise. As used herein, the term “about” refers to a ±10% variation from the nominal value unless otherwise indicated or inferred.

It should be understood that the order of steps or order for performing certain actions or operations is immaterial so long as the present teachings remain operable. For example, the methods described herein can be performed in any suitable order unless otherwise indicated or clearly inferable from the context. Moreover, two or more steps or actions can be conducted simultaneously.

At various places in the present specification, values are disclosed in groups or in ranges. It is specifically intended that the description include each and every individual subcombination of the members of such groups and ranges and any combination of the various endpoints of such groups or ranges. For example, an integer in the range of 0 to 40 is specifically intended to individually disclose 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39 and 40, and an integer in the range of 1 to 20 is specifically intended to individually disclose 1, 2, 3, 4, 5, 6, 7, 8, 9, 10, 11, 12, 13, 14, 15, 16, 17, 18, 19 and 20.

The use of any and all examples, or exemplary language provided herein, for example, “such as,” is intended merely to better illuminate the present teachings and does not pose a limitation on the scope of the invention unless claimed. No language in the specification should be construed as indicating any non-claimed element as essential to the practice of the present teachings.

Terms and expressions indicating spatial orientation or attitude such as “upper,” “lower,” “top,” “bottom,” “horizontal,” “vertical,” and the like, unless their contextual usage indicates otherwise, are to be understood herein as having no structural, functional or operational significance and as merely reflecting the arbitrarily chosen orientation of the various views of the present invention illustrated in certain of the accompanying figures.

The expression “gas permeable,” as it applies to a wall of a CPDX reactor unit herein, shall be understood to mean a wall structure that is permeable to gaseous CPDX reaction mixtures and gaseous product reformate including, without limitation, the vaporized liquid reformable fuel component of the gaseous CPDX reaction mixture and the hydrogen component of the product reformate.

The expression “liquid reformable fuel” shall be understood to include reformable carbon- and hydrogen-containing fuels that are a liquid at standard temperature and pressure (STP) conditions, for example, methanol, ethanol, naphtha, distillate, gasoline, kerosene, jet fuel, diesel, biodiesel, and the like, that when subjected to reforming undergo conversion to hydrogen-rich reformates. The expression “liquid reformable fuel” shall be further understood to include such fuels whether they are in the liquid state or in the gaseous state, i.e., a vapor.

The expression “gaseous reformable fuel” shall be understood to include reformable carbon- and hydrogen-containing fuels that are a gas at STP conditions, for example, methane, ethane, propane, butane, isobutane, ethylene, propylene, butylene, isobutylene, dimethyl ether, their mixtures such as natural gas and liquefied natural gas (LNG) which are mainly methane, petroleum gas and liquefied petroleum gas (LPG), which are mainly propane or butane but include all mixtures made up primarily of propane and butane, and the like, that when subjected to reforming undergo conversion to hydrogen-rich reformates.

The expression “CPDX reaction” shall be understood to include the reaction(s) that occur during catalytic partial oxidation reforming of a reformable fuel to a hydrogen-rich reformate.

The expression “gaseous CPDX reaction mixture” refers to a mixture including a gaseous liquid reformable fuel (for example, a vaporized liquid reformable fuel), a gaseous reformable fuel, or combinations thereof, and an oxygen-containing gas, for example, air. As used herein, a gaseous CPDX reaction mixture includes a vaporized liquid reformable fuel or a gaseous liquid reformable fuel.

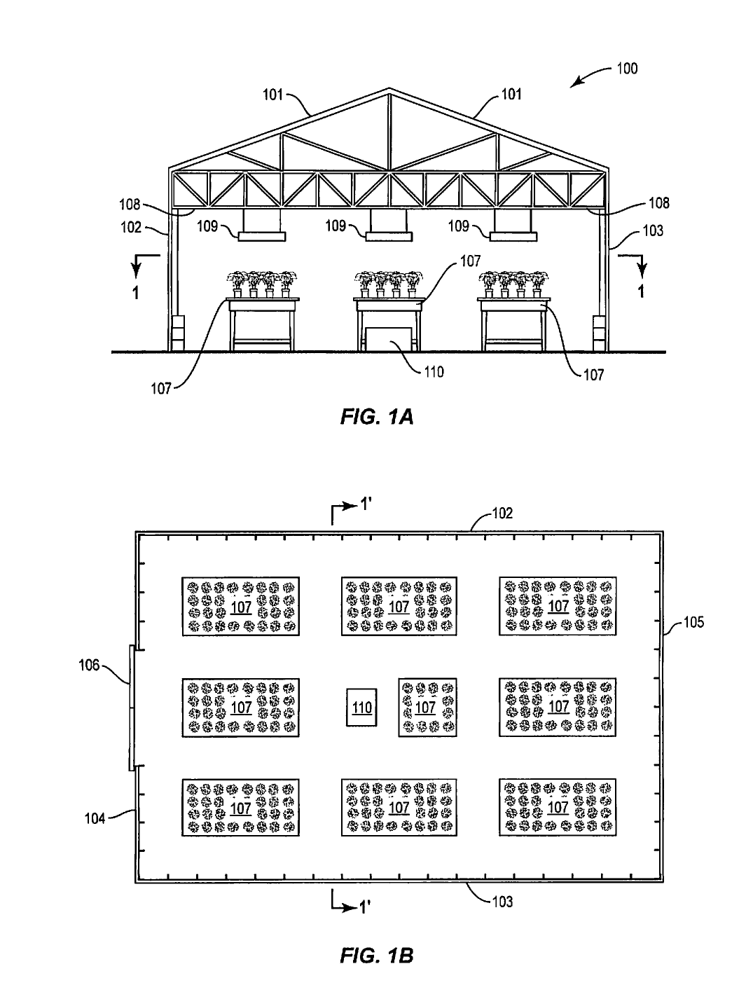

Referring now to the drawings, FIGS. 1A and 1B illustrate, respectively, cross section and plan views of one embodiment of plant cultivation system, greenhouse 100, in accordance with the present teachings.

As shown in FIGS. 1A and 1B, greenhouse 100 includes solar radiation-transmissive roof structure 101, side walls 102 and 103, front and rear walls 104 and 105, at least one entrance, for example, sliding door(s) 106 in front wall 107, plant cultivation beds 107, and upper frame member 108 from which grow lights 109 providing PAR and/or one or more other devices, assemblies, systems, etc., including those that like grow lights 109 draw electrical current for their operation, may be suspended. Illustrative of such devices, assemblies, systems, etc., are pipes and conduits and their associated pumps, blowers, valves, servo motors, etc., for introducing and controlling the distribution and flow of water, nutrients and/or hot exhaust gas produced by SOFC 110 throughout greenhouse 100. The hot exhaust from SOFC 110, which if desired may be distributed throughout greenhouse 100 by a system of conduits closer to ground level, in addition to containing carbon dioxide, contains waste heat which can be recovered so as to provide and/or maintain a desirable range of temperature within greenhouse 100. The carbon dioxide produced by SOFC 110 may be utilized by the plants under cultivation to promote their accelerated growth.

Greenhouse 100 may also be equipped with environmental controls including temperature sensors, PAR meters, carbon dioxide sensors/meters, humidity meters, etc., and a controller operating on suitable software for the automated control of the greenhouse environment in accordance with data inputs therefrom. The environmental controls may also include devices for adjusting the amount of solar radiation received during periods of sunshine and reducing both the loss of heat (by radiation and conduction) and synthetic PAR (by diffusion beyond solar radiation-transmissive roof 101 and walls 102-105). Such devices include electrochromic glass (“smart glass”) and solar shading apparatus various types of which are known. Suitable humidity levels for a particular plant cultivation environment may also be controlled in a variety of known and conventional ways, for example, ventilation means including moveable roof panels, blowers, and the like, and dehumidification devices, etc. These and other types of greenhouse equipment require electricity for their operation, the electricity being drawn directly or indirectly from the SOFC.

SOFC 110 may be provided as a single unit of sufficient wattage output to meet the power requirements of greenhouse 100, either by itself or supplemented with voltage from the power grid. It is also within the scope of the invention to combine two or more SOFCs of standardized construction into a correspondingly larger SOFC assembly in order to meet the electric power requirements of a given greenhouse design.

SOFC 110 can be positioned outside, and advantageously within, greenhouse 100 in any suitable location, for example, the approximately central location to surrounding plant cultivation beds 107 shown in FIG. 1B. While SOFC 110 can operate on oxygen supplied by the ambient air external and/or internal to greenhouse 100 (in the case of the latter, air enriched by photosynthetically produced oxygen), its carbon dioxide-containing hot exhaust will be discharged within the greenhouse to provide or promote a desirable plant cultivation environment therein.

SOFC 110 is connected to at least one electrical power-consuming device disposed within greenhouse 100, for example, grow lights 109. This electrical connectivity can be direct, i.e., at least a portion of the electrical current output of SOFC 110 can be routed directly to one or more electrical power consuming devices within greenhouse 100, or indirectly, i.e., electricity produced by the SOFC can be routed to the power grid from which electricity for greenhouse operation can be drawn as needed and/or to a rechargeable battery system to be drawn upon as operational requirements of the greenhouse require.

Since commercially-produced hydrogen for SOFC operation is not yet a commonplace reality, the SOFC component of the plant cultivation system of this invention must be capable of internally reforming a gaseous fuel feed, for example, a gaseous hydrocarbon such as methane, ethane, propane, butane or any of their mixtures in order to produce the hydrogen-rich reformate required for its operation, or the SOFC must be linked to an external CPDX reformer capable of processing a liquid and/or gaseous reformable fuel into hydrogen-rich reformate for utilization by the SOFC.

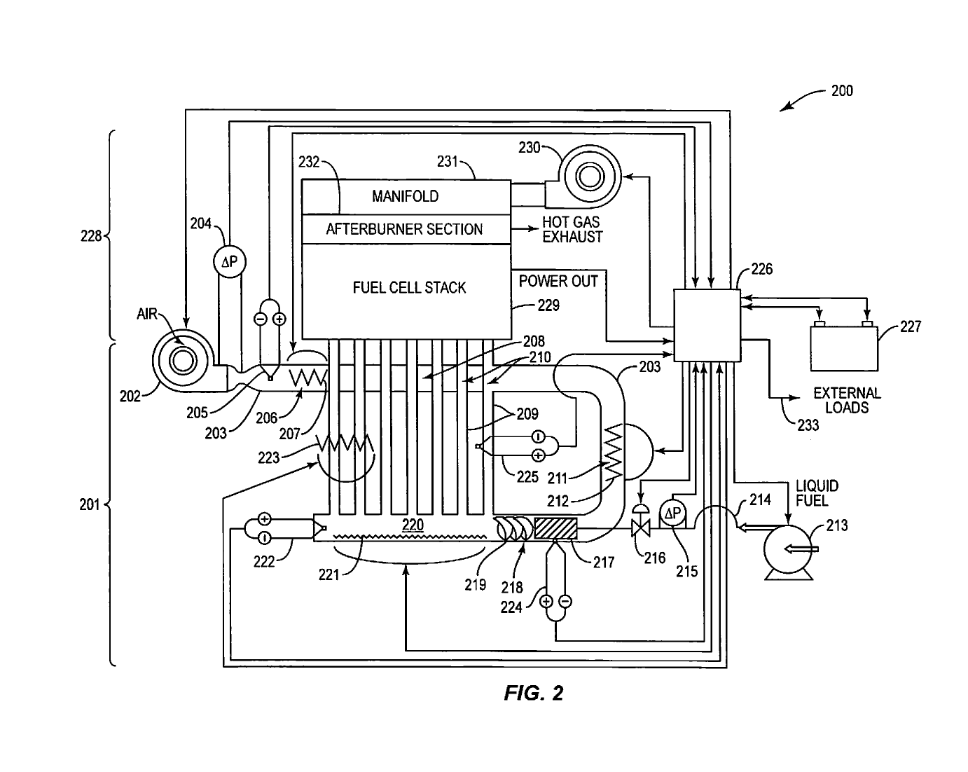

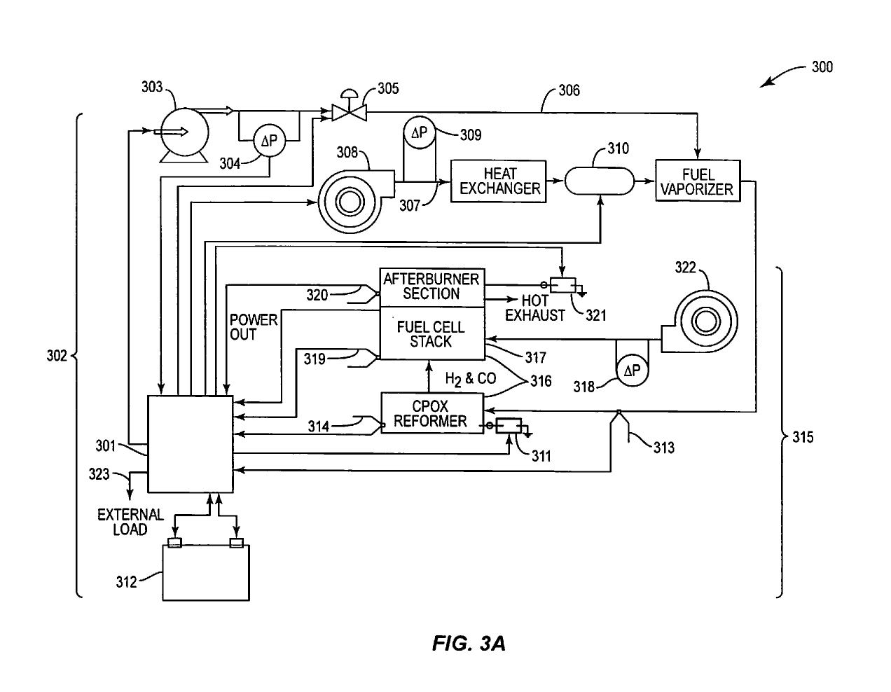

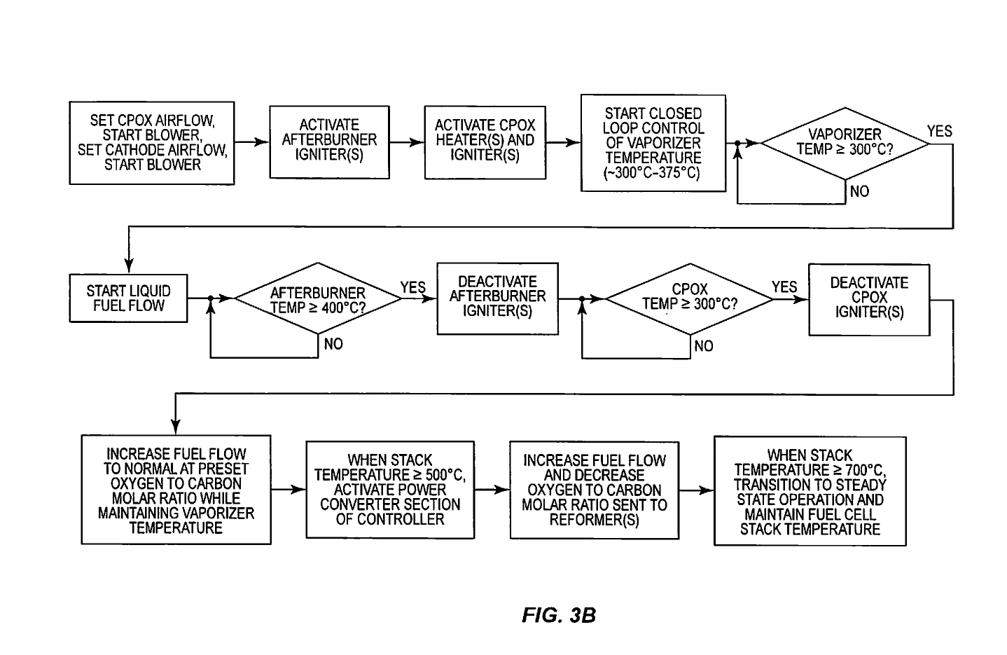

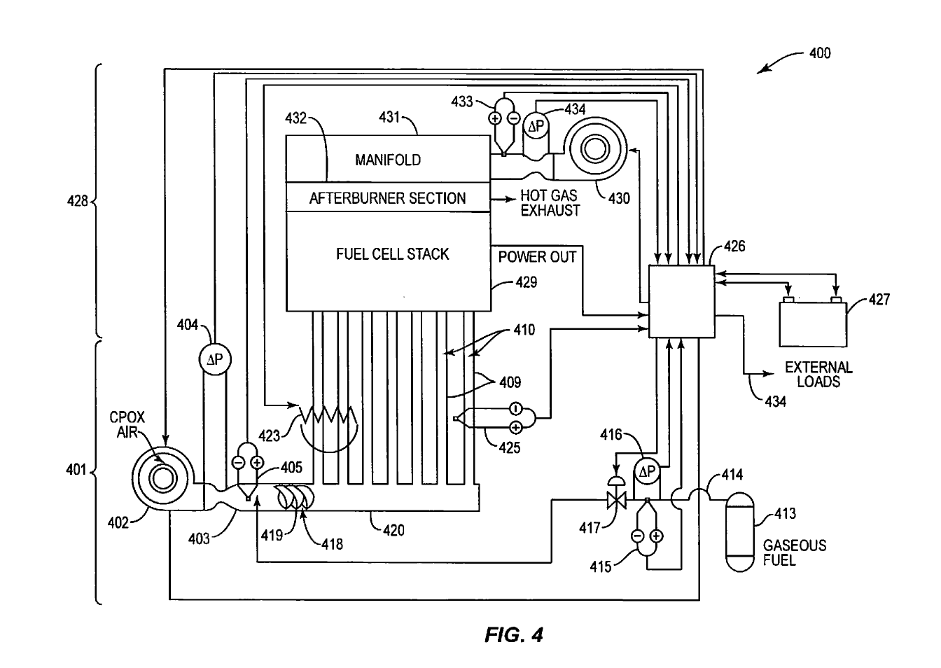

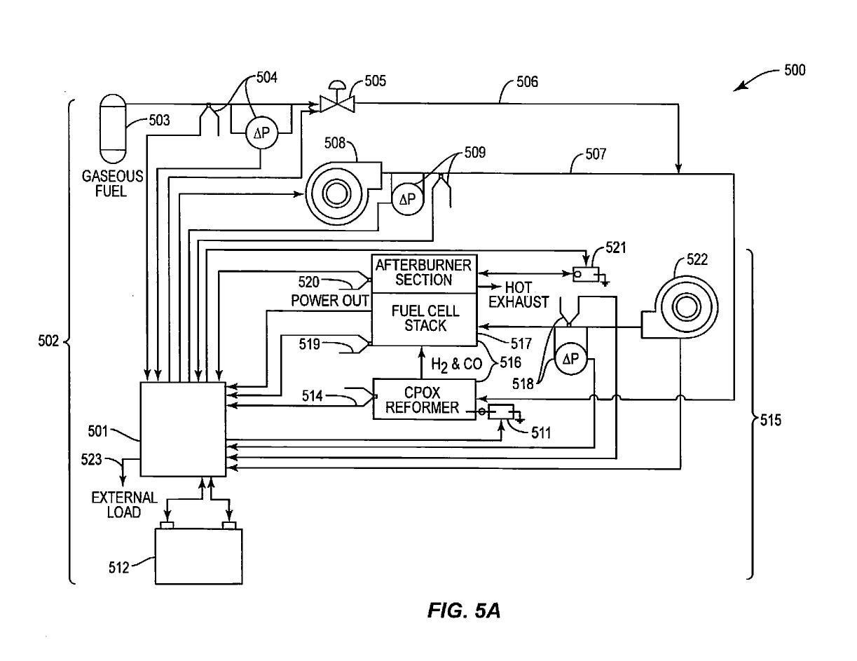

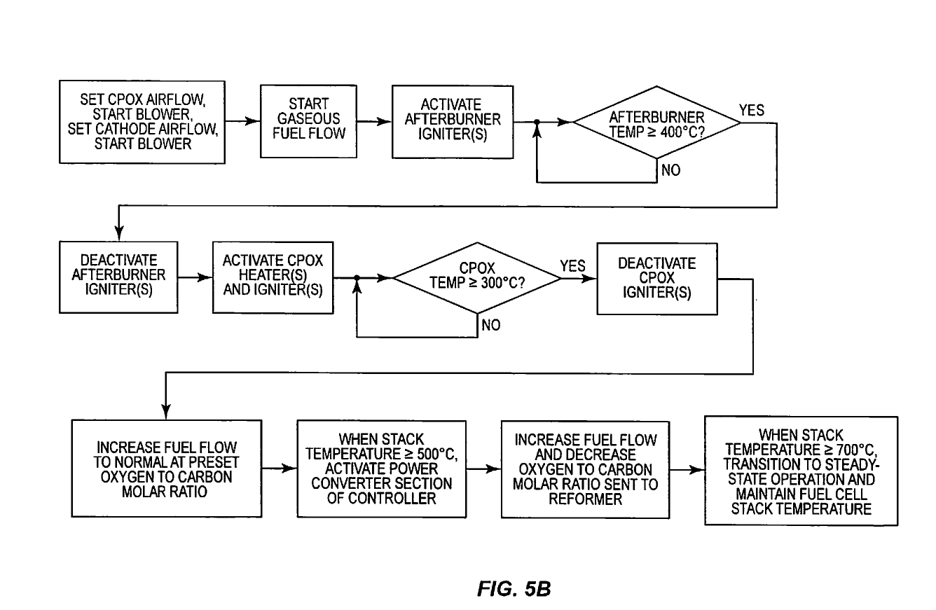

Suitable SOFCs of both types that can be incorporated within the plant cultivation system of the invention include, for example, the internally reforming SOFC of Finnerty et al. U.S. Pat. No. 8,435,683, the integrated liquid fuel CPDX reactor and SOFC system of pending Finnerty et al. U.S. provisional patent application Ser. No. 61/900,529, filed Nov. 6, 2013, and the integrated gaseous fuel CPDX reactor and SOFC system of pending Finnerty et al. U.S. provisional application Ser. No. 61/900,552, filed Nov. 6, 2013. The entire contents of the aforementioned Finnerty et al. U.S. patent and published U.S. patent applications are incorporated by reference herein. Embodiments of the integrated CPDX reformer-SOFC systems of Finnerty et al. applications 61/900,529 and 61/900552 are described below in connection with FIGS. 2, 3A and 3B (liquid fuel) and FIGS. 4, 5A and 5B (gaseous fuel).

FIG. 2A illustrates one embodiment of SOFC that may be incorporated in greenhouse 100 of FIGS. 1A and 1B, specifically, integrated liquid fuel CPDX reformer and SOFC system 200 which processes any reformable liquid fuel, for example, naphtha, distillate, gasoline, kerosene, diesel fuel, biodiesel, and the like.

As shown in FIG. 2A, integrated liquid fuel CPDX reformer-SOFC system 200 includes liquid fuel CPDX reformer section 201 coupled to SOFC section 228. Reformer section 201 includes centrifugal blower 202 for introducing oxygen-containing gas, exemplified here and in the other embodiments of the present teachings by air, into conduit 203, and for driving this and other gaseous streams (inclusive of vaporized fuel-air mixture(s) and hydrogen-rich reformates) through the various passageways, including open gaseous flow passageways, of the reformer section and fuel cell section. Conduit 203 can include flow meter 204 and thermocouple 205. These and similar devices can be placed at various locations within a liquid fuel CPDX reformer section and fuel cell section in order to measure, monitor and control the operation of an integrated reformer-fuel cell system as more fully explained in connection with the control system illustrated in FIG. 3A.

In a start-up mode of operation of exemplary integrated liquid fuel CPDX reformer-fuel cell system 200, air at ambient temperature, introduced by blower 202 into conduit 203, passes through first heating zone 206, where the air is initially heated by first heater 207, for example, of the electrical resistance type, to within a preset, or targeted, first range of elevated temperature at a given rate of flow. The initially heated air then passes through heat transfer zone 208 which in the steady-state mode of operation of integrated liquid fuel CPDX reformer-fuel cell system 200 is heated by heat of exotherm recovered from the CPDX reaction occurring within CPDX reaction zones 210 of tubular CPDX reactor units 209. Once such steady-state operation of integrated reformer-fuel cell system 200 is achieved, i.e., upon the CPDX reaction within CPDX reactor units 209 becoming self-sustaining, the thermal output of first heater 207 can be reduced or its operation discontinued since the incoming air will have already been heated by passage through heat transfer zone 208 to within, or approaching, its first range of elevated temperature.

Continuing further downstream within conduit 203, the air which has initially been heated, either by passage through first heating zone 206 during a start-up mode of operation or by passage through heat transfer zone 208 during a steady-state mode of operation, passes through second heating zone 211 where it is further heated by second heater 212, which can also be of the electrical resistance type, to within a second range of elevated temperature. A heater can operate to top-off the temperature of the previously heated air thereby satisfying several operational requirements of liquid fuel CPDX reformer section 201, namely, assisting in the regulation and fine-tuning of the thermal requirements of the reformer on a rapid response and as-needed basis, providing sufficient heat for the subsequent vaporization of liquid reformable fuel introduced further downstream into conduit 203 and providing heated gaseous CPDX reaction mixture.

Liquid reformable fuel, exemplified by automotive diesel/domestic heating oil, is continuously introduced via pump 213 through fuel line 214 equipped with optional flow meter 215 and optional flow control valve 216 and into conduit 203 where the fuel is vaporized by vaporizer system 217 utilizing heat from the heated air flowing from second heating zone 211. The vaporized, i.e., gaseous, fuel combines with the stream of heated air in mixing zone 218 of conduit 203. A mixer, for example, a static mixer such as in-line mixer 219, and/or vortex-creating helical grooves formed within the internal surface of conduit 203, or an externally powered mixer (not shown), are disposed within mixing zone 218 of conduit 203 in order to provide a more uniform fuel-air gaseous CPDX reaction mixture than would otherwise be the case.

The heated vaporized fuel-air mixture (heated gaseous CPDX reaction mixture) enters manifold, or plenum, 220 which functions to distribute the reaction mixture more evenly and, for example, at a more uniform temperature, into tubular CPDX reactor units 209. While the conduit and the manifold will ordinarily be surrounded by thermal insulation, the CPDX reaction mixture can still undergo a drop in temperature due to heat loss through the walls of the manifold, which typically has a greater volume, and hence a greater wall surface area, than that of a comparable length of conduit 203. Another factor that can cause a drop in the temperature of the CPDX reaction mixture within the manifold is the reduction in pressure and velocity which the mixture undergoes as it exits the conduit and enters the larger space of the manifold.

Reductions in the temperature of a CPDX reaction mixture due to either of these factors, particularly those occurring in regions of the reaction mixture that are proximate to or in contact with walls, corners and/or other recesses of the manifold, can induce localized condensation of vaporized fuel. To minimize the possibility of such condensation, a manifold can be provided with means for maintaining the temperature of the gaseous CPDX reaction mixture above the condensation threshold of its vaporized fuel component. For example, as shown in FIG. 2A, heater 221, of the electrical resistance type, and thermocouple or thermistor probe 222 for purposes of temperature control, are disposed within manifold 220 in order to accomplish this objective. As an alternative to a heater or in addition thereto, a reformer section can be provided with thermally conductive structure(s) for transferring heat of exotherm recovered from the CPDX reaction occurring within CPDX reaction zones of tubular CPDX reactor units to such locations within a manifold where the potential for condensation of fuel vapor can be greatest, for example, wall surfaces in the vicinity of the fuel-air outlets and/or other sites such as corners and other recesses of the manifold that could cause localized condensation of vaporized fuel.

From manifold 220, the heated CPDX reaction mixture is introduced into tubular CPDX reactor units 209. In one embodiment, a CPDX reactor unit 209 is configured as an elongate tube, the tube having an inlet for gaseous CPDX reaction mixture, an outlet for hydrogen-rich reformate, a wall with internal and external surfaces, the wall enclosing an open gaseous flow passageway with at least a section of the wall having CPDX catalyst disposed therein, thereon and/or comprising its structure, such catalyst-containing wall section and open gaseous flow passageway enclosed thereby defining a gaseous phase CPDX reaction zone 210, the catalyst-containing wall section being gas-permeable to allow gaseous CPDX reaction mixture to diffuse therein and product hydrogen-rich reformate to diffuse therefrom while remaining structurally stable under CPDX reaction conditions. Advantageously, a hydrogen barrier is attached to the external surface of the catalyst-containing wall section of CPDX reactor unit 209 so as to prevent or inhibit the loss of hydrogen from the reactor unit that in the absence of the barrier would result from the diffusion of hydrogen through and beyond such wall section.

In a start-up mode of operation of CPDX reformer section 201, igniter 223 initiates the CPDX reaction of the gaseous CPDX reaction mixture within CPDX reaction zones 210 of tubular CPDX reactor units 209 thereby commencing the production of hydrogen-rich reformate. Once steady-state CPDX reaction temperatures have been achieved (for example, from about 250° C. to about 1,100° C.), the reaction becomes self-sustaining and operation of the igniter can be discontinued. Thermocouples 224 and 225 are provided to monitor the temperatures of, respectively, the vaporization operation occurring within conduit 203 and the CPDX reaction occurring within CPDX reactor units 209, the temperature measurements being relayed as monitored parameters to reformer control system 226.

Reformer section 201 can also include a source of electrical current, for example, rechargeable lithium-ion battery system 227, to provide power, for example, during start-up mode of operation of integrated reformer-fuel cell system 200 for its electrically driven components such as blower 202, flow meters 204 and 215, heaters 207, 212 and 221, liquid fuel pump 213, flow control valve 216, igniter 223, and thermocouples 205, 222, 224 and 225 and, if desired, to store surplus electricity, for example, produced by SOFC section 228 during steady-state operation, for later use.

As further shown in FIG. 2A, hydrogen-rich reformate driven by blower 202 passes from CPDX reactor units 209 of reformer section 201 into SOFC stack 229, advantageously of the tubular variety, of SOFC section 228 where the hydrogen and oxygen-containing gas introduced by blower 230 into manifold 231 and thereafter into stack 229 undergo electrochemical conversion to electricity which is delivered through line 233 to one or more external loads such as grow lights 109 and/or any of the other electrical power-consuming devices referred to above in connection with greenhouse 100 of FIGS. 1A and 1B, the power grid and/or storage battery system. Combustible gas(es), for example, hydrocarbon(s), unconsumed hydrogen, and the like, contained in the spent gas(es) resulting from such electrochemical conversion can be made to undergo combustion in afterburner 232. Heat resulting from combustion taking place in afterburner 232 can be recovered, if desired, and utilized for the operation of the reforming section, for example, to preheat oxygen-containing gas and/or fuel during a steady-state mode of operation of the integrated reformer-fuel cell system. Part or even all of the heat of combustion in afterburner 232 can be introduced into greenhouse 100 of FIGS. 1A and 1B to maintain a plant growth-conducive temperature regime therein. The exhaust from afterburner 232, in addition to its heat content, also contains carbon dioxide and moisture/water vapor both of which are essential to plant growth. The afterburner exhaust can be released directly from afterburner 232 into greenhouse 100 but for better distribution, is advantageously conducted through a system of conduits to suitably situated outlets therein. If desired, the afterburner exhaust can be routed to a condenser with the resulting water condensate being utilized for plant cultivation purposes, either as is or with a metered amount of one or more nutrients, agrochemicals, etc., contained therein, and with the carbon dioxide being released to the greenhouse interior, either directly or through a system of conduits as aforementioned.

Control system 300 illustrated in FIG. 3A can control the operations of an integrated liquid fuel CPDX reformer-fuel cell system in accordance with the present teachings. As shown in FIG. 3A, control system 300 includes controller 301 to manage liquid fuel CPDX reformer 302 in its start-up, steady-state and shut-down modes of operation. The controller can be software operating on a processor. However, it is within the scope of the present teachings to employ a controller that is implemented with one or more digital or analog circuits, or combinations thereof.

Control system 300 further includes a plurality of sensor assemblies, for example, fuel pressure meter 304, air pressure meter 309, mixing zone thermocouple 313 and CPDX reaction zone thermocouple 314, cathode air pressure meter 318, fuel cell stack thermocouple 319, afterburner thermocouple 320, and the like, in communication with controller 301 and adapted to monitor selected operating parameters of reformer section 302 and fuel cell section 315.

In response to input signals from the sensor assemblies, user commands from a user-input device and/or programmed subroutines and command sequences, a controller can manage the operations of a liquid fuel CPDX reformer-fuel cell system. More specifically, as shown, controller 301 communicates with a control signal-receiving portion of the desired section or component of integrated reformer-fuel cell system 316 by sending command signals thereto directing a particular action. Thus, for example, in response to flow rate input signals from pressure meters 304, 309 and 318 and temperature input signals from thermocouples 313, 314, 319 and 320, controller 301 can send control signals to fuel pump 303 and/or fuel flow control valve 305, for example, to control the flow of fuel through fuel line 306 to conduit 307, to centrifugal blower 308 to control the flow of air into conduit 307 and drive the flow of heated gaseous CPDX reaction mixture within and through reformer section 302 and fuel cell section 315, to heater 310 to control its thermal output, to reformer igniter 311 and/or afterburner igniter 321 to control on-off states, to cathode air blower 322 to control the flow of cathode air to fuel cell stack 317, and to battery/battery recharger system 312 to manage its functions.

The sensor assemblies, control signal-receiving devices and communication pathways herein can be of any suitable construction such as those known in the art. The sensor assemblies can include any suitable sensor devices for the operating parameters being monitored. For example, fuel flow rates can be monitored with any suitable flow meter, pressures can be monitored with any suitable pressure-sensing or pressure-regulating device, and the like. The sensor assemblies can also, but do not necessarily, include a transducer in communication with the controller. The communication pathways will ordinarily be wired electrical signals but any other suitable form of communication pathway can also be employed.

In FIG. 3A, communication pathways are schematically illustrated as single- or double-headed arrows. An arrow terminating at controller 301 schematically represents an input signal such as the value of a measured flow rate or measured temperature. An arrow extending from controller 301 schematically represents a control signal sent to direct a responsive action from the component at which the arrow terminates. Dual-headed pathways schematically represent that controller 301 not only sends command signals to corresponding components of integrated reformer-fuel cell system 316 to provide a determined responsive action, but also receives operating inputs from reformer section 302, fuel cell section 315, and mechanical units such as fuel pump 303, fuel control valve 305, blowers 308 and 322, and measurement inputs from sensor assemblies such as pressure meters 304, 309 and 318, and thermocouples 313, 314, 319 and 320.

FIG. 3B presents a flow chart of an exemplary control routine that can be executed by a controller of a control system to automate the operations of a liquid fuel CPDX reformer-fuel cell system, for example, integrated reformer-fuel cell system 316. The flow chart can be executed by a controller at a fixed interval, for example, about every 10 milliseconds. The control logic illustrated in FIG. 3B performs several functions including the management of gaseous flows, heating, fuel vaporization and CPDX reaction temperatures in start-up and steady-state modes of operation and management of the procedure for the shut-down mode of reformer operation.

In various embodiments, the method can include, in a shut-down mode, reducing the fuel flow rate, for example, in step (viii), while maintaining a substantially constant molar ratio of oxygen to carbon. In certain embodiments, the method can include increasing the molar ratio of oxygen to carbon when the temperature within the CPDX reaction zones of CPDX reactor units approaches or falls below a level that would result in coke formation. Such an increase in the molar ratio can prevent or inhibit coke formation as the CPDX catalyst deactivates.

Embodiments of gaseous fuel CPDX reformers, fuel cells, integrated reformer-fuel cell systems and methods of CPDX reforming and producing electricity in accordance with the present teachings are generally described above and elsewhere herein. The following description with reference to the figures of drawing embellishes upon certain of the features and others of the foregoing embodiments of the invention and should be understood to discuss various and specific embodiments without limiting the essence of the invention.

In contrast to CPDX reformer-SOFC system 200 of FIG. 2A which processes a liquid fuel such as diesel or kerosene as the source of hydrogen-rich reformate for the operation of its SOFC section 228, CPDX reformer-SOFC system 400 of FIG. 4 processes a gaseous fuel such as pipeline natural gas, re-gasified LNG, LPG or liquid butane as the source of hydrogen-rich reformate for the operation of its SOFC section 428.

As shown in FIG. 4, integrated gaseous fuel CPDX reformer-fuel cell system 400 includes gaseous fuel CPDX reformer section 401 coupled to SOFC section 428. Reformer section 401 includes centrifugal blower 402 for introducing oxygen-containing gas, exemplified here and in the other embodiments of the present teachings by air, into conduit 403, and for driving this and other gaseous streams (inclusive of gaseous fuel-air mixture(s) and hydrogen-rich reformates) through the various passageways, including open gaseous flow passageways, of the reformer section and fuel cell section. Conduit 403 can include flow meter 404 and thermocouple 405. These and similar devices can be placed at various locations within a gaseous fuel CPDX reformer section and fuel cell section in order to measure, monitor and control the operation of an integrated reformer-fuel cell system as more fully explained in connection with the control system illustrated in FIG. 5A.

In a start-up mode of operation of exemplary integrated gaseous fuel CPDX reformer-fuel cell system 400, air at ambient temperature, introduced by blower 402 into conduit 403, combines with gaseous reformable fuel, exemplified here and in the other embodiments of the present teachings by propane, introduced into conduit 403 at a relatively low pressure from gaseous fuel storage tank 413 through fuel line 414 equipped with optional thermocouple 415, flow meter 416, and flow control valve 417. The air and propane combine in mixing zone 418 of conduit 403. A mixer, for example, a static mixer such as in-line mixer 419, and/or vortex-creating helical grooves formed within the internal surface of conduit 403, or an externally powered mixer (not shown), are disposed within mixing zone 418 of conduit 403 in order to provide a more uniform propane-air gaseous CPDX reaction mixture than would otherwise be the case.

The propane-air mixture (gaseous CPDX reaction mixture) enters manifold, or plenum, 440 which functions to distribute the reaction mixture more evenly into tubular CPDX reactor units 409. In a start-up mode of operation of CPDX reformer section 401, igniter 423 initiates the CPDX reaction of the gaseous CPDX reaction mixture within CPDX reaction zones 410 of tubular CPDX reactor units 409 thereby commencing the production of hydrogen-rich reformate. Once steady-state CPDX reaction temperatures have been achieved (for example, from about 250° C. to about 1,100° C.), the reaction becomes self-sustaining and operation of the igniter can be discontinued. Thermocouple 425 is positioned proximate to one or more CPDX reaction zones 410 to monitor the temperature of the CPDX reaction occurring within CPDX reactor units 409. The temperature measurements can be relayed as a monitored parameter to reformer control system 426.

Reformer section 401 can also include a source of electrical current, for example, rechargeable lithium-ion battery system 427, to provide power, for example, during start-up mode of operation of integrated reformer-fuel cell system 400 for its electrically driven components such as blower 402, flow meter 404, flow control valve 417, igniter 423, and, if desired, to store surplus electricity, for example, produced by SOFC section 428 during steady-state operation, for later use.

SOFC section 428 includes SOFC stack 429, preferably of the tubular variety, an afterburner, or tail gas burner, 432, a blower 430 for introducing air, evenly distributed by manifold 431, to the cathode side of fuel cell stack 429 to support the electrochemical conversion of fuel to electricity therein and to afterburner 432 to support combustion of tail gas therein, and optional thermocouple 433 and flow meter 434 to provide temperature and pressure measurement inputs to control system 426. Hydrogen-rich reformate produced in gaseous CPDX reformer section 401 enters SOFC stack 429 and undergoes electrochemical conversion therein to electricity, delivered though line 434 to one or more external loads such as grow lights 109 and/or a any of the electrical power-consuming devices referred to above in connection with greenhouse 100 of FIGS. 1A and 1B, the power grid and/or storage battery system, and gaseous effluent, or tail gas, containing by-product water (as steam), carbon dioxide, and in many cases, combustibles gas(es), such as hydrocarbon(s), unconsumed hydrogen and/or other electrochemically oxidizable gas(es) such as carbon monoxide. This gaseous effluent from SOFC stack 429 then enters afterburner 432 where any combustible components contained therein undergo combustion to water (steam) and carbon dioxide utilizing air provided by blower 430. The hot exhaust gas from afterburner 432, containing carbon dioxide and water vapor, can be introduced into greenhouse 100 of FIGS. 1A and 1B to maintain a plant growth-conducive temperature therein and augment the ambient carbon dioxide level which further promotes plant growth.

Control system 500 illustrated in FIG. 5A can control the operations of an integrated gaseous fuel CPDX reformer-SOFC system 516 in accordance with the present teachings. As shown in FIG. 5A, control system 500 includes controller 501 to manage gaseous fuel CPDX reformer 502 in its start-up, steady-state, and shut-down modes of operation. The controller can be software operating on a processor. However, it is within the scope of the present teachings to employ a controller that is implemented with one or more digital or analog circuits, or combinations thereof.

Control system 500 further includes a plurality of sensor assemblies, for example, thermocouple and associated gaseous fuel pressure meter 504, thermocouple and associated CPDX/anode air pressure meter 509, CPDX reformer zone thermocouple 514, thermocouple and associated cathode air pressure meter 518, fuel cell stack thermocouple 519, and afterburner thermocouple 520, in communication with controller 501 and adapted to monitor selected operating parameters of reformer section 502 and SOFC section 515.

In response to input signals from the sensor assemblies, user commands from a user-input device and/or programmed subroutines and command sequences, a controller can manage the operations of a gaseous fuel CPDX reformer-fuel cell system. More specifically, as shown, controller 501 communicates with a control signal-receiving portion of the desired section or component of integrated CPDX reformer-fuel cell system 516 by sending command signals thereto directing a particular action. Thus, for example, in response to temperature and flow rate input signals from thermocouples and associated pressure meters 504, 509 and 518, and temperature input signals from thermocouples 514, 519 and 520, controller 501 can send control signals to fuel flow control valve 505, for example, to control the flow of gaseous fuel from gaseous fuel storage tank 503 through fuel line 506 to conduit 507, to centrifugal blower 508 to control the flow of air into conduit 507 and drive the flow of heated gaseous CPDX reaction mixture within and through reformer section 502 and hydrogen-rich reformate within and through the anode side of SOFC section 515, to control on-off states, and to battery/battery recharger system 512 to manage its functions. Similarly, in response to input signals from various sensor assemblies, controller 501 can send control signals to centrifugal blower 522 to control the flow of air within and through the cathode side of SOFC section 515 and to the afterburner where the air supports combustion of the combustible component(s) of the tail gas therein.

The sensor assemblies, control signal-receiving devices and communication pathways herein can be of any suitable construction such as those known in the art. The sensor assemblies can include any suitable sensor devices for the operating parameter being monitored. For example, fuel flow rates can be monitored with any suitable flow meter, pressures can be monitored with any suitable pressure-sensing or pressure-regulating device, and the like. The sensor assemblies can also, but do not necessarily, include a transducer in communication with the controller. The communication pathways will ordinarily be wired electrical signals but any other suitable form of communication pathway can also be employed.

As in the case of FIG. 3A, communication pathways in FIG. 5A are schematically illustrated as single- or double-headed arrows. An arrow terminating at controller 501 schematically represents an input signal such as the value of a measured flow rate or measured temperature. An arrow extending from controller 501 schematically represents a control signal sent to direct a responsive action from the component at which the arrow terminates. Dual-headed pathways schematically represent that controller 501 not only sends command signals to corresponding components of integrated gaseous fuel CPDX reformer-SOFC system 516 to provide a determined responsive action, but also receives operating inputs from reformer section 502, fuel cell section 515, and mechanical units such as fuel control valve 505, and blowers 508 and 522, and measurement inputs from sensor assemblies such as thermocouple/pressure meters 504, 509 and 518, and thermocouples 514, 519 and 520.

FIG. 5B presents a flow chart of an exemplary control routine that can be executed by a controller of a control system to automate the operations of a gaseous fuel CPDX reformer-fuel cell system, for example, integrated gaseous fuel CPDX reformer-SOFC system 516. The flow chart can be executed by a controller at a fixed interval, for example, about every 10 milliseconds. The control logic illustrated in FIG. 3B performs several functions including the management of gaseous flows, CPDX reaction temperatures in start-up and steady-state modes of operation, and management of the procedure for the shut-down mode of integrated reformer-fuel cell system operation.

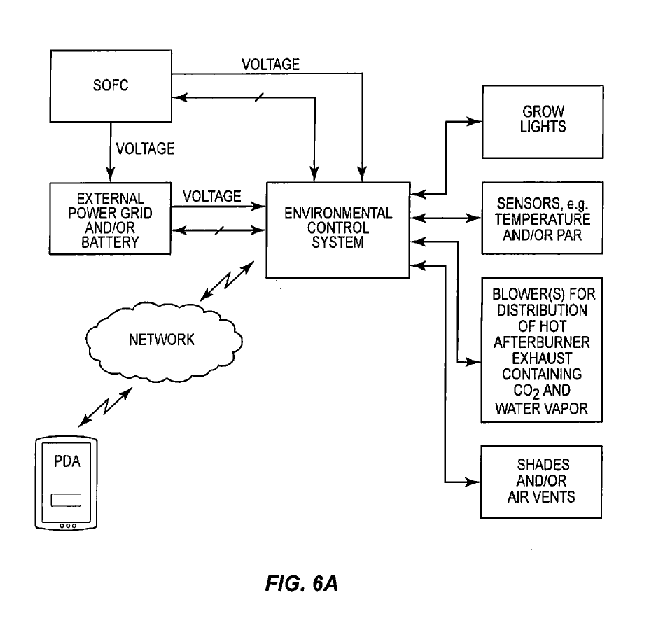

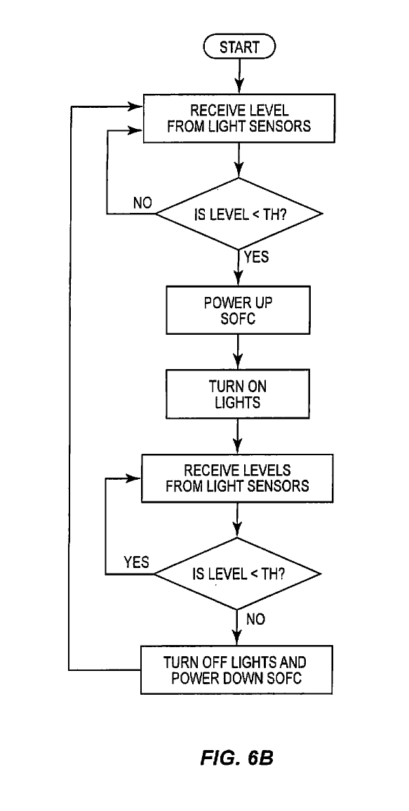

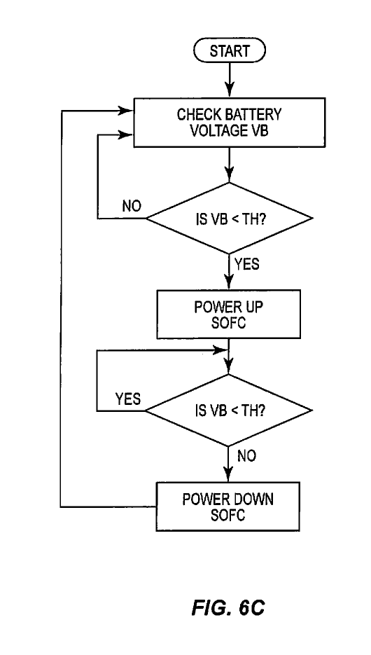

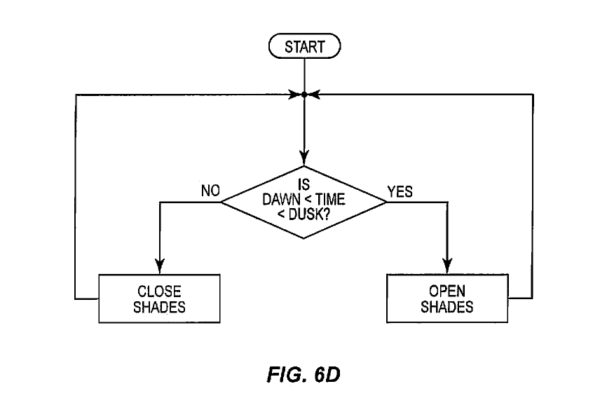

FIG. 6A is a schematic block diagram illustrating an environmental control system for the control of the plant cultivation system according to the present disclosure. Environmental control system provides overall control of the plant cultivation system. The environmental control system can include a processor for executing programs, a memory for storing data and programs, an input device, e.g. a mouse and/or keyboard, and an output device, e.g. a display. The environmental control system can also include switching circuits to control the flow of electricity to the connected environmental systems, e.g. the grow lights, the sensors, and/or the blowers.

The environmental control system is connected to the SOFC via control lines to receive operating conditions from and provide operating commands to the SOFC. The environmental control system can also be connected to a battery via control lines to monitor the voltage levels and operating conditions of the battery. The SOFC is shown providing voltage to the environmental control system and the external power grid and/or battery. The environmental control system can also be connected directly to the power grid and/or battery for an additional supply of power. The environmental control system can switch power from the SOFC, power grid and/or battery to the connected plant cultivation systems, e.g. grow lights.

In addition, the environmental control system is shown connected to a network, e.g. the Internet, to provide access to the system via the network. Although the connection is illustrated as a wireless connection, the connection between the environmental control system and the network can be a hard wired connection. The Environmental control system can be accessed remotely through the network via any compatible device, e.g. a smart phone, personal digital assistant (PDA), table and/or desktop computer; other devices are contemplated.

The environmental control system can also control the operation of shades used to control the amount of sunlight entering the greenhouse or the amount of ambient light leaving the greenhouse. The environmental control system can also control the operation of fresh air vents used to open and close air vents to control the amount of air into or out of the greenhouse.

FIG. 6B presents a flow chart of an exemplary control routine that can be executed by a controller of the environmental control system to automate the operation of the plant cultivation system. The thresholds (TH) shown therein can be preset thresholds or controlled by a user depending on the needs of the plants.

FIG. 6C presents a flow chart of an exemplary control routine that can be executed by a controller of the environmental control system to automate the operation of the charging of the battery for the plant cultivation system. Again, the thresholds (TH) shown therein can be preset thresholds or controlled by a user depending on the needs of the plants.

FIG. 6D presents a flow chart of an exemplary control routine that can be executed by a controller of the environmental control system to automate the operation of the shades of the plant cultivation system. Although shown controlled on the basis of daylight hours, other bases are contemplated depending on the needs of the plants.

The present teachings encompass embodiments in other specific forms without departing from the spirit or essential characteristics thereof. The foregoing embodiments are therefore to be considered in all respects illustrative rather than limiting on the present teachings described herein. Scope of the present invention is thus indicated by the appended claims rather than by the foregoing description, and all changes that come within the meaning and range of equivalency of the claims are intended to be embraced therein.

1. An enclosed plant cultivation system which comprises:
a) a plant cultivation enclosure; and,
b) a solid oxide fuel cell electrically connected to at least one electrical power-consuming device disposed within the plant cultivation enclosure, waste heat and carbon dioxide outputs of the solid oxide fuel cell being in thermal and in gaseous flow communication, respectively, with the interior of the plant cultivation enclosure.

2. The system of claim 1 wherein the plant cultivation enclosure is open to at least a portion of incident solar radiation.

3. The system of claim 1 wherein the plant cultivation system is closed to at least a portion of solar radiation.

4. The system of claim 1 wherein the plant cultivation system is selectively open or closed to at least a portion of solar radiation.

5. The system of claim 1 wherein at least one of a hydroponic system and an aeroponic system is disposed within the plant cultivation enclosure.

6. The system of claim 1 wherein photosynthetic oxygen within the plant cultivation enclosure is in gaseous flow communication with the solid oxide fuel cell.

7. The system of claim 1 wherein the solid oxide fuel cell is at least one of an internal reforming solid oxide fuel cell, integrated liquid fuel catalytic partial oxidation reformer and solid oxide fuel cell system and integrated gaseous fuel catalytic partial oxidation reformer and solid oxide fuel cell system.

8. The system of claim 6 wherein photosynthetic oxygen within the plant cultivation enclosure is in gaseous flow communication with an inlet of the reformer and/or an inlet of the solid oxide fuel cell.

9. The system of claim 6 wherein the internal reforming solid oxide fuel cell and the integrated gaseous fuel catalytic partial oxidation reformer and fuel cell system are fueled by at least one of gaseous hydrocarbon and gaseous cracked liquid hydrocarbon, and the integrated liquid fuel catalytic partial oxidation reformer and fuel cell system is fueled by vaporized liquid hydrocarbon.

10. The system of claim 8 wherein the gaseous hydrocarbon is at least one of methane, ethane, propane, butane, natural gas and petroleum gas and the liquid hydrocarbon is at least one of naphtha, distillate, gasoline, kerosene, jet fuel, diesel fuel and biodiesel.

11. The system of claim 1 wherein the at least one electrical power-consuming device is at least one emitter of photosynthetically active radiation.

12. The system of claim 1 wherein the at least one electrical power-consuming device is at least one of a sensor, meter, fluid pump, valve, electric motor, servo motor, centrifugal blower, adjustable ventilation panel, synthetic PAR and/or interior heat conservation system, dehumidifying system and environmental monitoring and control system.

13. The system of claim 1 further comprising a controller for the automated operation of the solid oxide fuel cell.

14. The system of claim 1 further comprising a rechargeable storage battery system for storing electricity produced by the solid oxide fuel cell.

15. The system of claim 1 wherein the solid oxide fuel cell is disposed within the plant cultivation enclosure.

16. A plant cultivation system comprising:
a) a plant cultivation enclosure; and,
b) a solid oxide fuel cell which is at least one of an internal reforming solid oxide fuel cell, integrated liquid fuel catalytic partial oxidation reformer and solid oxide fuel cell system and integrated gaseous fuel catalytic partial oxidation reformer and solid oxide fuel cell system, the solid oxide fuel cell being electrically connected to at least one electrical power-consuming device disposed within the interior of the plant cultivation enclosure which is at least one of a lamp, lighting device or light emitting diode providing photosynthetically active radiation, waste heat and carbon dioxide outputs of the solid oxide fuel cell being in thermal and in gaseous flow communication, respectively, with the interior of the plant cultivation enclosure.

17. A method of plant cultivation which comprises:
a) placing at least one plant to be cultivated within a plant cultivation enclosure having a source of water, a source of nutrients essential to the growth of the plant and at least one electrical power-consuming source of photosynthetically active radiation;
b) operating at least one solid oxide fuel cell to provide electrical current for the operation of the at least one electrical power-consuming source of photosynthetically active radiation, waste heat and carbon dioxide outputs of the solid oxide fuel cell being introduced into the plant cultivation enclosure to at least partly bring about and/or maintain environmental conditions within the plant cultivation enclosure that are favorable to the growth of the plant; and,
c) cultivating the at least one plant under the favorable environmental conditions at least partly brought about and/or maintained by operating the at least one solid oxide fuel cell.

18. The method of claim 17 wherein the plant to be cultivated is cultivated by operation of at least one of a hydroponic system and an aeroponic system disposed within the plant cultivation enclosure.

19. The method of claim 17 wherein the solid oxide fuel cell is at least one of an internal reforming solid oxide fuel cell, integrated liquid fuel catalytic partial oxidation reformer and solid oxide fuel cell system and integrated gaseous fuel catalytic partial oxidation reformer and solid oxide fuel cell system.

20. The method of claim 19 wherein photosynthetic oxygen within the plant cultivation enclosure is utilized by the solid oxide fuel cell and/or by the reformer for operation.

21. The method of claim 19 wherein the internally reforming solid oxide fuel cell and integrated gaseous fuel catalytic partial oxidation reformer and solid oxide fuel cell system are fueled with at least one of methane, ethane, propane, butane, natural gas and petroleum gas, and the integrated liquid fuel partial oxidation reformer and solid oxide and cell system is fueled with at least one of naphtha, distillate, gasoline, kerosene, jet fuel, diesel fuel and biodiesel.

22. The method of claim 17 wherein the operation of the solid oxide fuel cell to maintain a desired plant growth environment within the enclosure is controlled by a controller.
